(19) United States
(12) Patent Application Publication
(10) Pub. No.: US 2006/0148527 A1
(43) Pub. Date: Jul. 6, 2006

(54) Mobile graphics device and server

(76) Inventor: Alan Wayne Blount, Somerville, MA (US)

Correspondence Address: HAVERSTOCK & OWENS LLP, 162 NORTH WOLFE ROAD, SUNNYVALE, CA, 94086, US

(21) Appl. No.: 10/539,714

(22) PCT Filed: Nov. 27, 2003
(86) PCT No.: PCT/EP03/13845

§ 371 Date: Feb. 13, 2006

Related U.S. Application Data
(60) Provisional application No. 60/434,491, filed on Dec. 18, 2002.

(51) Int. Cl. H04M 1/00; H04B 1/38

(52) U.S. Cl. 455/566; 455/556.1

(57) ABSTRACT

A mobile graphics display device comprises a touch sensitive display screen coupled to a touch screen processor. The touch screen processor is operable to generate first ink data representative of an input drawing action applied to the touch sensitive display screen. The device includes a graphics display and a graphics image processor operable to display images representative of at least the first ink data on the graphics display screen in combination with hand drawn images which may have already been created. A wireless communications processor is operable to communicate the first ink data from the mobile graphics display device to another graphics display device, and to receive other ink data from the other graphics display device, the other ink data being representative of other drawing action. The graphics display processor is operable to generate a representation of the other ink data with respect to the representation of the first ink data according to a common reference. The mobile graphics display device is thereby arranged to exchange hand drawn images with another device.

### FIELD OF THE INVENTION

The present invention relates to graphics display devices and more particularly to mobile graphics display devices. The present invention also relates to servers operable to provide a facility for communicating graphics data.

### BACKGROUND OF THE INVENTION

Instant messaging systems are known to provide a facility for exchanging message text between computer systems. Text typed into a window on a computer screen is forwarded to another computer at which a user known to the originator of the message is logged-in. The user at which the computer receiving the message is logged-in can then type a further message in response to the first message which is then returned over a computer network to the first computer for display in correspondence with the text sent by the originator. The instant messaging system provides an indication of users, which are currently logged-in at various terminals on the computer network, to each user of the system. Such an indication is known as presence or presence information. Accordingly, by selecting one of the present users which are logged-in at a computer terminal connected to the computer network, a message may be sent to that user with the knowledge that it is highly likely that the receiving user will read the text and respond with a return message. Known instant messaging systems therefore include a facility for identifying when particular users are logged-in and active. A user is active when present at the computer terminal at which they are logged-in and using the computer terminal. As such presence information is generally known to identify users which are present to receive data, whereas availability information may provide a further indication that a user is not only present but available to respond to a message. As such the presence information alone may provide a facility for indicating that a user is available to receive a message, but may not respond to the message until later.

Known instant messaging systems include for example the system provided by AOL.com which is known as a “buddy chat” and provides a list as part of a window appearing in a graphical user interface of users which are present at their computer terminals and therefore available to receive messages.

### SUMMARY OF THE INVENTION

According to the present invention there is provided a mobile graphics display device comprising a touch sensitive display screen coupled to a touch screen processor. The touch screen processor is operable to generate first ink data representative of an input drawing action applied to the touch sensitive display screen. The device includes a graphics display and a graphics image processor operable to display images representative of at least the first ink data on the graphics display, and a wireless communications processor. The wireless communications processor is operable to communicate the first ink data from the mobile graphics display device to another graphics display device, and to receive other ink data from the other graphics display device, the other ink data being representative of other drawing action. The graphics image processor is operable to generate a representation of the other ink data with respect to the representation of the first ink data according to a common reference.

Known drawing packages and drawing representation software provide a facility for representing drawings made by motion of a pen, wand or finger upon a tablet or touch sensitive screen as ink data which may be communicated from one display device to another. An example of such graphics display software is provided at www.scrawl.com or www.ritemail.com. For example riteMail™ provides a downloadable software application which is an interactive hand-written email application that allows a user to create, store, send and receive freehand drawing and writing on hand-held devices, tablets or desktops in a variety of styles and colors.

Embodiments of the present invention provide a mobile graphics display device with a facility for representing hand drawn images and for communicating these images to a corresponding graphics display device. The mobile graphics display device may also receive ink data representative of drawing action made on the other display device. The original drawing made on the mobile graphics display device is then arranged to be displayed with respect to the ink data received from the other graphics display device. As such a facility is provided for communicating using hand drawn and written images in which only ink data representing the newly added hand drawn image is communicated to the other graphics display device. Correspondingly, only ink data representing a further addition to a developed hand drawn image is received by the mobile graphics display device from another device. The ink data representing the further addition is used to update the hand drawn images developed by the devices in accordance with the exchange of ink data. Accordingly, a mutual exchange of hand drawn images is made possible which may be utilised in a variety of applications including coordinating the design of a feature remotely between two or more separate graphics display devices. Only ink data representing a new addition to a hand drawn image developed by two or more devices in accordance with an exchange of ink data is communicated between the devices. As such, a substantial reduction in the amount of data which must be communicated to represent the image with respect to the amount of data in the image itself.

As will be appreciated only one of the devices may be a mobile graphics device. The other graphics device with which ink data is exchanged may be connected to a data communications network such as Ethernet, LAN or the Internet.

The term ink data is used as a term of art to identify data which is representative of a visual reproduction of hand drawn graphics.

The ink data may be generated in accordance with a common reference such as a grid of points with a predetermined width. The length or height of the drawing space may be quasi-continuous, since the height or length dimension is increased by “scrolling down” on the display. The width of the common reference may be set at one of a predetermined set of values. In some embodiments the width may be predetermined to be the same size for all devices. However, in other embodiments the common reference may be predetermined for all graphics display devices, so that devices with different sized screens or utilising a grid with a different number of points may adjust the representation of the received ink data accordingly.

The mobile graphics display device may communicate a presence signal providing an indication that the graphics display device is available to send and receive ink data to at least one other graphics display device. Correspondingly, the data processor may be operable to receive a presence signal from another graphics display device, that presence signal being indicative that the other graphics display device is available to send and/or receive ink data from the mobile graphics display device. The data processor is operable in response to the presence signal to display an indication on the graphics display screen that the other display device is available to send and/or receive ink data. As a result the graphics display devices may be arranged to provide each other with presence data. The presence data is indicative of whether or not graphics display devices in accordance with a predetermined group are available to exchange ink data. Accordingly, the mobile graphics display device may select a device associated with another user from the group and exchange ink data with that graphics display device.

Advantageously, the ink data may be compressed in accordance with a compression encoding process to reduce an amount of data, which is required to represent the ink data.

According to an aspect of the present invention there is provided a server comprising a data communications processor operable to receive ink data from a first graphics display device and to receive ink data from at least one other graphics display device. The communications processor includes a connection control processor operable to maintain connection information identifying the first graphics display device and the other graphics display device. The server includes a server control processor operable to store the ink data from the first graphics display device and the ink data from the other graphics display device in a data store in accordance with a sequence of receipt. The server control processor is operable to communicate the ink data from the first graphics display device to the other graphics display device and to communicate the ink data from the other graphics display device to the first graphics display device. In some embodiments the graphics display device may be arranged to communicate other types of data with the ink data. Examples of such data may include a Universal Resource Indicator (URI) providing an indication of the location of data resource which may be an image file such as PNG, GIF or JPEG or may be the image file itself representing a picture or photograph.

A server embodying the present invention provides a facility for receiving and sending ink data generated by different graphics display devices and for storing that ink data in a data store arranged, for example, as a relational or a sequential database. As such, if ink data is being exchanged between two graphics display devices, the ink data may be stored in association with the effect that exchanged ink data may be represented within a common graphics framework on the graphics display devices. Accordingly, communication of graphics images, text and other hand drawn information may be effected within a common reference space.

As mentioned above, the server may store the ink data as a relational or sequential database. For a sequential database, the ink data is stored in accordance with a sequence of receipt of ink data. However, in a relational database the ink data is stored in association with a time that the ink data was generated or received, together with the device from which the ink data was received. In addition, the database may also include an indication that the ink data is a new layer on to of some previously generated ink data, or that the ink data represents a new drawing which should not be layered.

Various aspects and features of the present invention are defined in the appended claims.

### BRIEF DESCRIPTION OF THE DRAWINGS

Embodiments of the present invention will now be described by way of example only with reference to the accompanying drawings where like parts are provided with corresponding reference numerals and in which:

FIG. 1 is a schematic representation of a mobile graphics display device embodying the present invention;

FIG. 2 is a schematic block diagram of parts forming the mobile graphics display device of FIG. 1;

FIG. 3 is a schematic block diagram of a mobile radio network connected to a server according to an example embodiment of the present invention;

FIG. 4 is a schematic block diagram of parts making up the server according to the example embodiment of the present invention shown in FIG. 3;

FIG. 5 is a schematic block diagram of an architectural arrangement of a collection of graphics display devices connected to a server via the Internet;

FIG. 6 is an example configuration of graphics display devices connected to a server via a mobile radio network;

FIG. 7 is a further example configuration of graphics display devices communicating via a mobile radio network;

FIG. 8 is a schematic block diagram of a pair of mobile graphics display devices provided for use in operation with a common service provider;

FIG. 9 is a flow diagram illustrating the operation of the mobile graphics display device according to an embodiment of the invention;

FIG. 10 is a flow diagram illustrating a process though which a graphics display device sends and responds to presence information from other graphics display devices;

FIG. 11 is a flow diagram illustrating a process for establishing a group of users and for notifying the presence of users to other members of the group as performed by a graphics display server; and

FIG. 12 is a flow diagram illustrating the exchange of ink data as performed by the graphics display server according to an embodiment of the invention.

### DESCRIPTION OF THE EXAMPLE EMBODIMENTS

Example Implementation

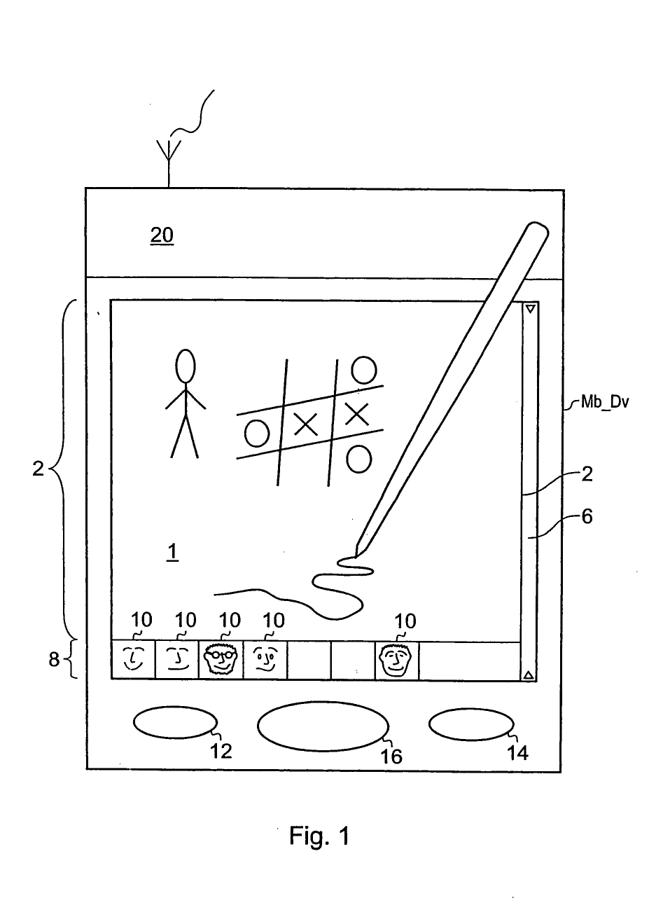

FIG. 1 provides an example illustration of a mobile graphics display device according to an embodiment of the present invention. In FIG. 1 a combined touch sensitive and display screen is provided as part of a handheld or palm top PC. One example implementation uses a COMPAQ IPAQ™, which provides a combined touch sensitive and graphics display screen. Accordingly, within the display screen 1 there is provided a drawing area 2 within which hand drawn images text and designs may be made using a tablet pen 4 a wand or a user's finger. As shown in FIG. 1, the tablet pen 4 is used to draw on the touch screen 2. Also shown within the display screen 1 is a scroll bar area 6 and an icon display area 8 within which icons representative of users 10 are displayed. As with conventional handheld PCs, the PC shown in FIG. 1 also includes control buttons 12, 14 and a jog or rocker selection switch 16 which is used to control and select menu items from the PC. The handheld PC shown in FIG. 1 is also provided with a radio communications link 20 which in accordance with one example embodiment operates in accordance with the IEEE 802.11 standard. Effectively, however the handheld PC shown in FIG. 1 forms a mobile graphics display device in which drawings may be made on the display 1, which may be communicated to another graphics display device.

Instant Messaging

Embodiments of the present invention provide a facility for exchanging hand drawn graphics images between graphics devices such as the one shown in FIG. 1 and a corresponding graphics device. According to one embodiment hand drawn images may be exchanged with any of a predefined group of users. The predefined group may be established in accordance with a user-selected list. The list may be established for example using an instant messaging system. Accordingly, if someone is using their graphics display device and is therefore present, then an indication is provided that this user is available to exchange hand drawn images. In some embodiments, an iconic representation 10 which for example may be a photograph such as a JPEG image of each user may be highlighted when a user is available for exchanging hand drawn images. Thus, the arrangement of data indicating the presence of a user for responding to an availability for exchanging hand drawn graphics may be provided in accordance with an instant messaging server which will be explained in the following paragraphs.

However, briefly summarised the instant messaging service operates with the effect that when a user is available to receive ink data representing a hand drawn image, because that user has turned on his device, then the presence of that user to receive and send ink data is indicated to the other users. To this end, in one embodiment the representation of the icons is changed within the display, such as for example making these brighter, with respect to other icons representing users who have not switched on their device, or are otherwise not available to receive and/or send ink data

Exchange URI Data

In other embodiments of the invention the mobile graphics display device may be provided with a facility for sending and receiving other data with the ink data. An example of such data would be a prepared illustration or an image in the form for example of a JPEG file. Another example is that of a Universal Resource Indicator (URI) address, which provides an indication of the location of a data resource such as a JPEG image or an MPEG image sequence, and audio and/or video sequence or a movie clip. Embodiments of the present invention can be arranged to send such data with the ink data by dragging and dropping a representation of the data onto the display screen, using the tablet pen. The ink data or a representation of the data is then communicated to other display devices, for representation with respect to the common display area with the other ink data.

More Detailed Explanation of an Embodiment

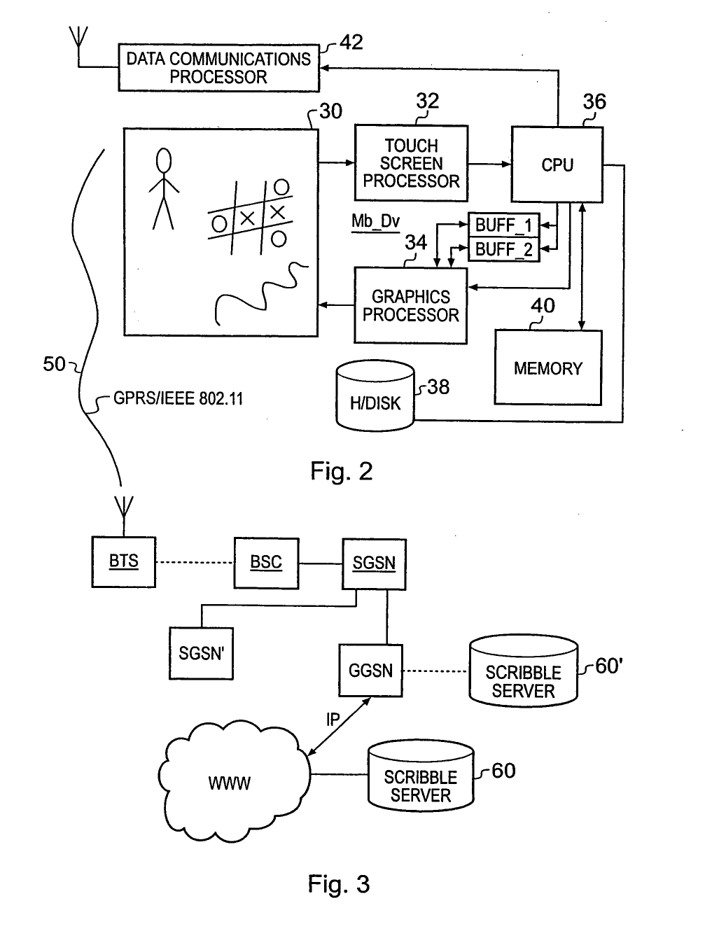

In FIG. 2 a mobile graphics display device comprises a combined touch sensitive tablet and display screen 30 which is connected to a touch screen processor 32 and a graphics processor 34. A touch screen processor 32 and the graphics processor 34 are connected to the CPU 36. The graphics processor 34 is provided with two data buffers BUFF_1, BUFF_2. The CPU 36 is provided with a mass storage device such as a hard disc 38 and a flash memory or a dynamic memory 40. A flash memory is preferable for mobile applications due to an economic power consumption, which such devices provide. The combined touch sensitive tablet and display screen 30 provides a facility to generate data representative of hand drawn images. A tablet pen or other implement is used to draw on the screen 30. The drawing action of the pen on the screen 30 generates data which is representative of the drawing action. In correspondence with the drawing action the display screen changes to represent the images created by the hand drawings. The data which is representative of hand drawing action and is created thereby is known to those skilled in the art as ink and will be referred to in the following description as ink data

The touch screen processor 32 generates the ink data in correspondence with the movement of the pen on the display screen 30 in correspondence with the drawing action. The ink data is fed to the CPU 36 and fed back to the graphics processor 34 to reproduce on the display screen the ink, thus providing the user with the impression that a hand drawn image is being created directly on the display screen 30. The ink data created by the user after drawing on the touch screen 1 is fed to the second data buffer BUFF_2 by the CPU. The new ink data stored in the second buffer BUFF_2 is used by the graphics display processor 34 to form a composite hand drawn image which is then updated and stored in the first data buffer BUFF_1 and displayed on the display screen. Similarly, ink data received by another graphics device via a wireless communications link (explained below) is received by the CPUI and stored in the first buffer BUFF_1. The ink data received from the other graphics display device is combined by the graphics display device 34 with the ink data presently displayed in an incremental manner and stored in the second buffer BUFF_2. The combined image represented by the ink data formed in the second buffer BUFF_2 is used to update the hand drawn images developed on the screen 1.

The hard disc 38 provides software and other applications for implementing the drawing function and the memory 40 provides the CPU with a facility for storing data temporarily or reading data from the hard disc for execution.

The mobile graphics display device according to the embodiment shown in FIG. 2 is also provided with a data communications processor 42. For the example embodiment shown in FIG. 2, the data communications processor is arranged to send and receive data in accordance with the General Packet Radio System (GPRS) interface provided on enhanced GSM networks. However in other embodiments data may be sent and received using a wireless communications standard such as IEEE 802.11. A line 50 represents data communications via the GPRS interface with a base station within a GPRS enabled GSM network. The GPRS communications network is illustrative of a wireless radio communications link via which the ink data may be communicated with another graphics display device. However, embodiments of the present invention are not limited to any particular air-interface standard.

FIG. 3 provides a schematic block diagram of a GPRS enabled GSM network. A more detailed operation of a GPRS network is provided in chapter 6 of “GSM, cdmaOne and 3G Systems,” by R. Steele, C. -C. Lee and P. Gould, published by John. Wiley & Sons, ISBN 0 471 49185 3. As with conventional GSM networks the mobile graphics display processor communicates with a base station BTS which is connected to a base station switching centre BSC. In accordance with a GSM network that supports GPRS, a Serving GPRS support node SGSN is connected to the BSC and further SGSN nodes may be connected to the Serving GPS support node SGSN. A Gateway GPRS Support Node GGSN connects the serving GPRS support node to other data communications networks. As shown in FIG. 3 the Gateway GPRS support node GGSN is connected to the Internet WWW in accordance with the Internet Protocol (IP).

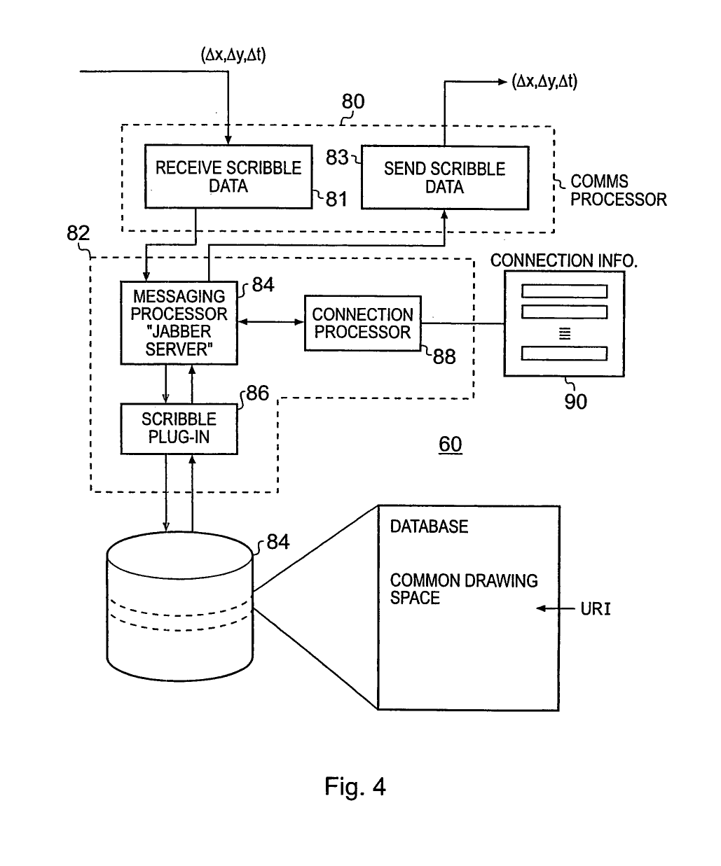

As shown in FIG. 3 a server for providing a facility for exchanging ink data between graphics display devices connected to the network may be connected to either the Internet WWW or to the Gateway GPRS Support Node GGSN. The Internet provides a facility for communicating the ink data in accordance with TCP/IP as Internet Packets to the graphics display server 60. The graphics display server 60 which appears in FIG. 3 is shown in more detail in FIG. 4.

The graphics display server 60 shown in FIG. 4 comprises a data communications processor 80 and a server control processor 82 which is connected to a server data store 84 using a graphics plug-in processor 86. As will be appreciated in some embodiments the server control processor 82 and the graphics plug-in processor 86 may be implemented in software for execution on a computer. The communications processor 80 may be formed as a combination of hardware and software as an Internet connection therefore operate in accordance with Internet Protocol (IP) to send and receive data in the form of IP packets. The communications processor 80 includes a receiver 81 for ink data, and a transmitter 83 for ink data.

In one embodiment the server control processor 82 may operate in accordance with “JABBER” so that the server operates as a Jabber server. Jabber is an open source instant messaging server. Jabber utilises an Extensible Mark-up Language (XML) to perform routing and messaging. More information on Jabber may be found at www.jabber.com.

The Jabber server provides the facility for instant messaging services, for a predefined group of users. The Jabber server may operate to identify the presence of users from that group by providing a pop-up window in a display screen indicating the presence or activity of the user concerned. In addition since the Jabber server provides an instant messaging facility users may exchange text via dialogue boxes with the effect that they can communicate text with each other. As shown in FIG. 4 the server control processor 82 also includes messaging processor 84 a connection processor 88 which is provided with memory 90 which includes a list of connection identifiers, connection numbers or addresses through which data may be received and sent to devices corresponding to those addressees. A “Plug-in” software module, which will be referred to as a scribble plug-in 86, provides a facility for storing ink data within the database 84 with respect to a relative sequence of receipt. The sequence of receipt may in some embodiments include a temporal indication of when that ink data was received.

The operation of the graphic display server shown in FIG. 4 will now be described. Ink data generated for example by the mobile graphics display device shown in FIG. 2 is received via the GPRS network and the Internet WWW at the communications processor 80. The ink data is received from the data communications processor 80 and fed to the server control processor 82 forming part of the Jabber server 60. The ink data is then stored by the scribble plug-in processor 86 within the data store 84 in association with other ink data received from other graphics display devices. By storing the ink data in an associated manner within the data store 84, a common drawing space may be created with respect to a sequence of receipt and with which hand drawn images within that common drawing space may be represented. Therefore once a graphics display device communicates ink data to the server 60, this ink data is then communicated, as well as being stored within the data store 84 to other active users having graphics display devices which are present to receive ink data. An indication that these devices are present is provided by the Jabber server 60 as part of the instant messaging facility. Other graphics display devices may send ink data to the graphics display server 60. Since these are routed back through the Internet WWW to the server control processor 82 they may also be stored in the data store 84 in association with the other ink data. Correspondingly, other data may be communicated to other graphics display devices, such as JPEG files and URI addresses as explained above. By distributing ink data with respect to a common reference space, to each of the graphics display devices each of the display devices can form a super imposed set of hand drawn images contributed by any of the other graphics display devices. Accordingly a facility is provided for exchanging hand drawn images.

In some embodiment the ink data is stored in the data store 84 in association with data indicating a time of receipt of the ink data. To this end the server may include a clock (not shown in Figures). Alternatively a graphics display device creating the ink data may time stamp that ink data, the time stamp being communicated and stored with in the ink data in the data store by the server. A further alternative is that a part of the communications network via which the ink data is received may provide time information, which may be stored in association with the ink data in the data store.

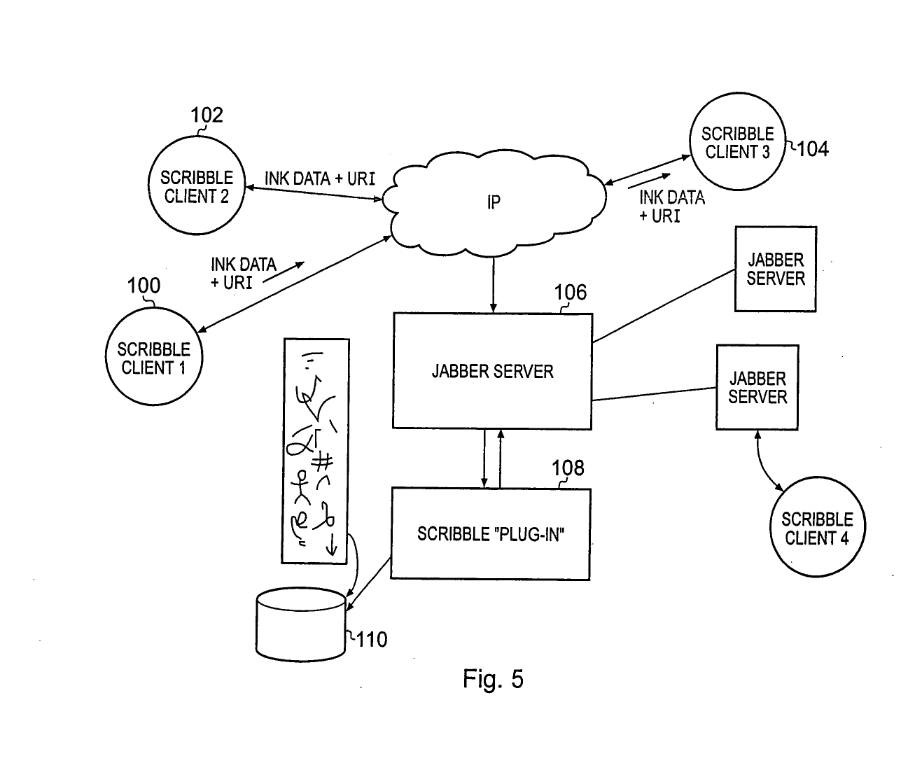

FIG. 5 provides a high level representation of the arrangement of interconnected graphics display devices using a server operating as a Jabber server. As shown in FIG. 5 three graphics display clients 100, 102 and 104 are connected via an Internet Protocol IP to a graphics display server 106. In correspondence with the embodiments shown in FIG. 4 a scribble plug-in 108 is connected to the Jabber server 106 and to a data store 110 which is arranged in accordance with a sequential or relational database to store the ink data received from the graphics display clients 100, 102, 104. The Jabber server 60 may also be connected to other Jabber servers to which other graphics display clients may also be connected. Therefore, it will be appreciated that a plurality of graphics display clients may be connected to a Jabber server and correspondingly a plurality of Jabber servers may be connected together either directly or via the Internet WWW. Thus further graphics display clients may be connected to the Jabber server 106 via another Jabber server to provide an arrangement for exchanging hand drawn graphics between several users within for example a predefined group.

Compression Encoding

In some embodiments compression encoding may be utilised to increase an amount of data, which can be stored. Compression encoding can also be used to facilitate communication of the ink data between the mobile graphics display device and the server. As such, compression encoding may be utilised both in the graphics display server and in the graphics display devices.

For the mobile graphics display the ink data may be compression encoded by the data communications processor 42 before being transmitted to another graphics display device via the server. Correspondingly, the data communications processor 42 would include a decompression processor to decompress ink data, which has been compression encoded by other graphics devices. In other embodiments the CPU may be arranged to perform the compression encoding to facilitate storage and communication of the ink data.

The graphics display server may be arranged to compression encode a sequence of hand drawn images from users and this compression encoded sequence is then stored within the data store 110. Other more current hand drawn images may be compression encoded before being stored in the data store 110 although it will be appreciated that compression encoding may or may not be used. Accordingly, any of the graphics display clients may request a history of a particular exchange of hand drawn images which have been exchanged between other users of a group and stored in a data store 110. As such, a graphics display client arriving late or joining late to an image exchange session may catch up with earlier produced images.

Various compression encoding techniques could be used to compress the ink data. One example, which could be used, is Huffman coding.

Other Configurations

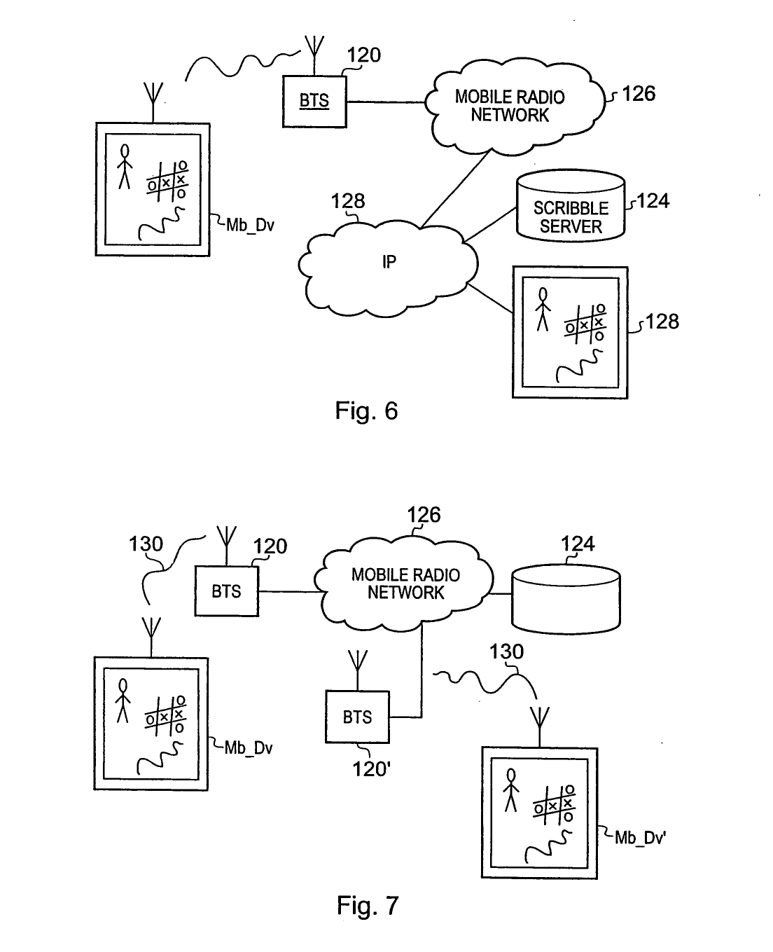

FIGS. 6 and 7 provide further examples of graphics display devices in accordance with an embodiment of the invention. In FIG. 6 a mobile graphics display device is connected via a wireless communications link to a base station 120 and to a graphics display server 124 via a mobile radio network 126 and the internet or an intranet 128. However, another graphics display device may be connected to the graphics display server 24 via the Internet WWW and may not be a mobile graphics display device, but may be formed from a personal computer connected to a network. Although in the example embodiment shown in FIG. 3 and in FIG. 4 the radio communications link is provided in accordance with a GPRS enabled GSM network, it will be appreciated that embodiments of the present invention are not limited to either GPRS or EEE 802.11 standards. As will be appreciated any wireless communications standard may be used and embodiments of the invention are not limited to any particular radio access standards, but may find application with third generation mobile radio systems such as W-CDMA, TD-CDMA or CDMA 2000.

In the further embodiment shown in FIG. 7 two graphics display devices MGDV are connected to the graphics display server 124 via a mobile data communications link represented as lines 130.

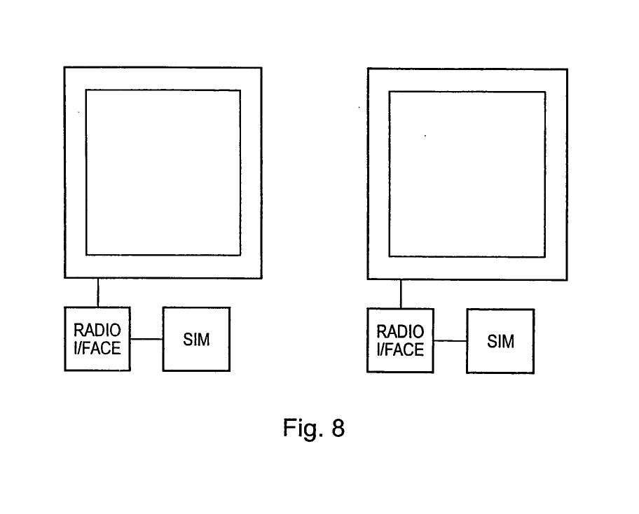

A further example application of embodiments of the present invention is shown in FIG. 8. FIG. 8 provides two mobile graphics display devices provided by the same service provider. The wireless radio link maybe provided via a suitable mobile radio telephone standard such as GPRS, WAP or High Speed Circuit Switched Data. The mobile graphics display devices shown in FIG. 8 are dedicated display devices. The graphics display devices are provided with a graphics display combined with a touch sensitive screen for generating data. The display devices are provided with a radio interface and a Subscriber Identity Module (SIM) associated with the same mobile operator. Therefore, for this example embodiment, paired devices may be sold for example as a professional tool for communicating hand drawn representations between a pair of users or for example as children's toy in which hand drawn images may be exchanged between two children.

Summary of Operation

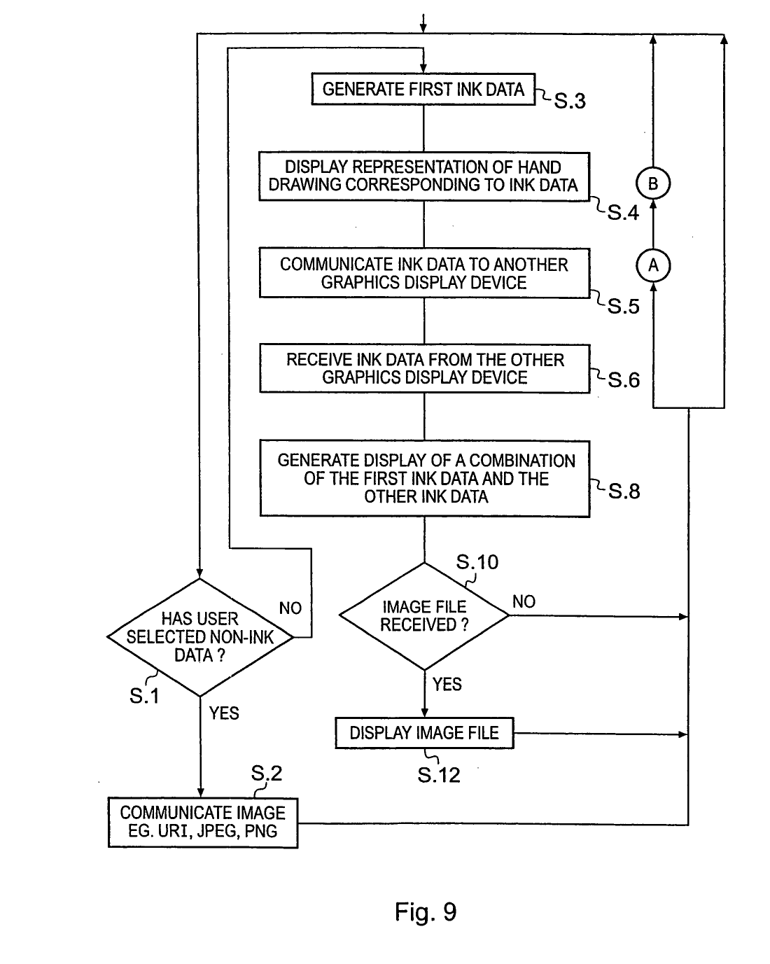

A summary of the operation of the graphics display device and the graphics display server will now be provided with reference to the flow diagrams appearing in FIGS. 9, 10, 11 and 12.

FIG. 9 provides a flow diagram illustrating the operation of the mobile graphics device according to an embodiment of the invention. The steps are explained as follows:

S1: As will be appreciated, the user may optionally select non-ink data representing other images, such as photographs or pictures for communication to another graphics display device, or may proceed to step S3 and make a hand drawing to generate ink data.

S2: If non-ink data is selected then this is communicated via the wireless communications link. The non-ink data representing an image may be in the form of a URI address, JPEG file or PNG or any similar way of representing images or picture data. Processing then proceeds to step S10 described below. Otherwise processing loops around to the start with the input of steps S1 and S3.

S3: Ink data is produced by the mobile graphics supply device by drawing on the touch screen.

S4: The ink data drawn on the screen is produced on the display screen in accordance with hand drawing action which formed the ink data.

S5: The ink data generated by drawing on the touch screen is then communicated to another graphics display device using the wireless interface via the graphics display server. As explained above the ink data is received via the wireless communications link at the graphics display server and stored in the database 84. The graphics display server then communicates the received ink data to another graphic display device.

S6: The mobile graphics display device then receives ink data created by another graphics display device. The ink data is received from the graphics display server after this has been stored in the database 84 in association with the first ink data.

S8: The data processor of the mobile graphics display device then generates a representation of the other ink data received from the other graphics display device in combination with the first ink data. The ink data from the other graphics display device and the mobile graphics display device are therefore displayed together on the same screen. Processing then proceeds to step S10.

S10: At decision step S10, it is determined whether the mobile graphics display device received ink data from another graphics display device, if not then processing loops around to steps S1 and S3.

S12: If the mobile graphics display device has received ink data from another graphics display device via the graphics display server, then this is displayed on the display screen in combination with the ink data already present.

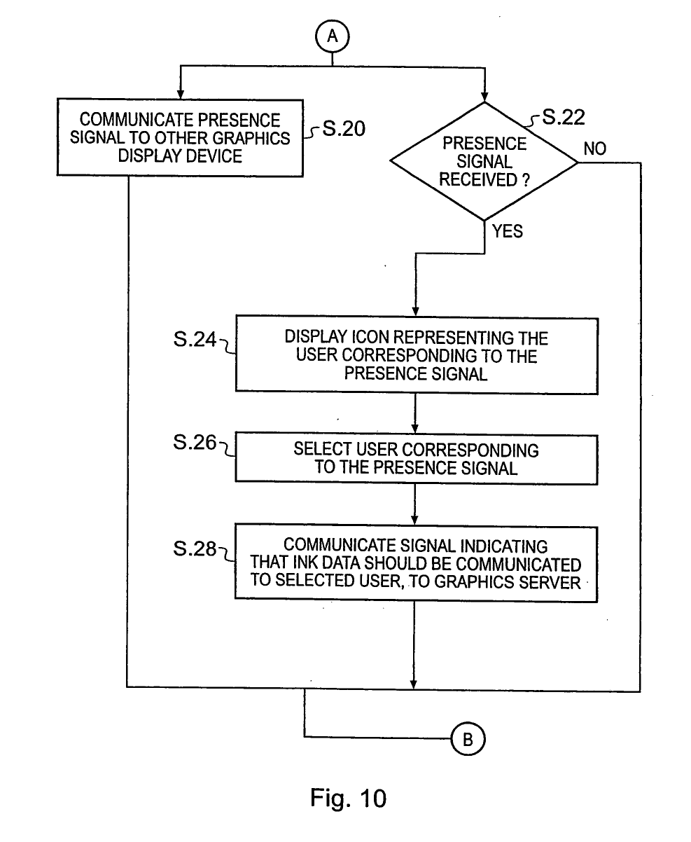

As shown in FIG. 9 the flow diagram then loops back to the start via two paths one of which includes steps shown between nodes A and B which are those represented in the flow diagram in FIG. 10.

FIG. 10 provides an illustrative representation of steps involved in an embodiment of the invention, which operates, to utilise presence data to indicate whether a graphics display device is ready to exchange ink data.

S20: If the mobile graphics display device is ready to communicate ink data to other display devices, then a presence signal is sent to the graphics display devices via the graphic display server and the wireless interface.

S22: Alternatively the mobile graphics display device may have received a presence signal from another device. If the device has not received a presence signal then the flow moves to the end node B.

S24: A presence signal from a particular user is correlated with users from the group, which have been pre-stored in the mobile graphics display device. An iconic representation of the user corresponding to the presence signal received may then be highlighted or may appear on the screen of mobile graphics display device.

S26: The user of the mobile graphics display device may then select a user, which has sent presence signals.

S28: The mobile graphics display device is responsive to the user selecting a user indicated as present, to communicate a signal indicating that ink data should be communicated to that selected user and thereafter exchanged with the selected user. The signal indicating that the mobile graphics display device should exchange ink data with the device which has indicated its presence is communicated to the graphics server so that thereafter data stored in association maybe communicated mutually to each of the display devices.

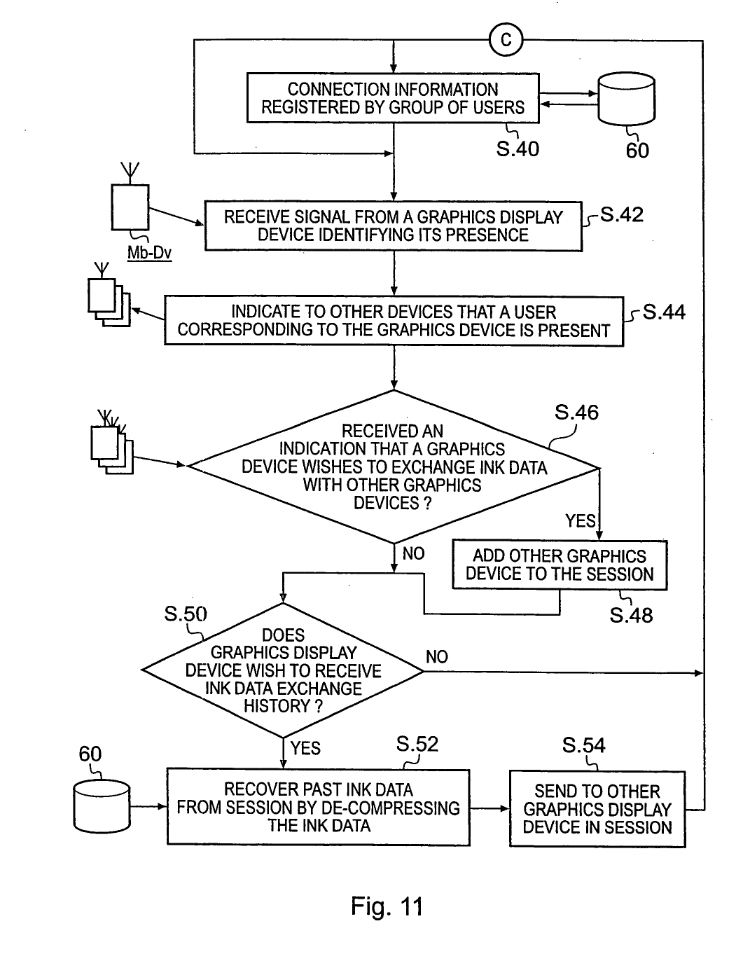

An example illustration of the steps of operation performed by the graphics display server in accordance with the embodiment of the present invention is illustrated in FIG. 11. The flow diagram shown in FIG. 11 will now be described.

S40: Connection information identifying a group of users is registered by these users with the graphics display server. The registration process may be conducted on an interactive basis or maybe downloaded to the server. However, in the connection information database a group of users is identified so that when one of these users indicates its presence then this presence is communicated to the other users of the group. However, if this connection information has already been registered then this step maybe by-passed.

S42: The mobile graphics display device communicates a signal identifying its presence.

S44: The presence of the graphics display device indicated to the server is then communicated to other devices within the group registered within the server.

S46: The server then determines whether it has received an indication that a graphics display device from the group wishes to exchange ink data with other graphics display devices which have indicated there presence. If there is no indication that a new graphics display devices wishes to exchange ink data with other graphics display devices then process moves to S50.

S48: If the server receives an indication that a graphics display device wishes to exchange data with another graphics display device which is present then this other device is added to this session.

S50: The server may receive an indication that a graphics display device wishes to receive ink data associated with a history of exchanges between the group. If no such indication is received then the flow passes back to the start of the flow diagram.

S52: The server in response to the request for a past history of ink data exchanged by the group recovers this past history associated with the session from the data store. In some embodiments the data may have been compressed. If this data is passed a certain temporal period, such as 24 hours, then the server may operate in some embodiments to compression encode the exchanged ink data. Accordingly, and optionally the server may offer the graphics display device requesting the data the option of retrieving data associated with the session before a certain period has passed.

S54: The history of exchanged ink data is then sent to the other graphics display device.

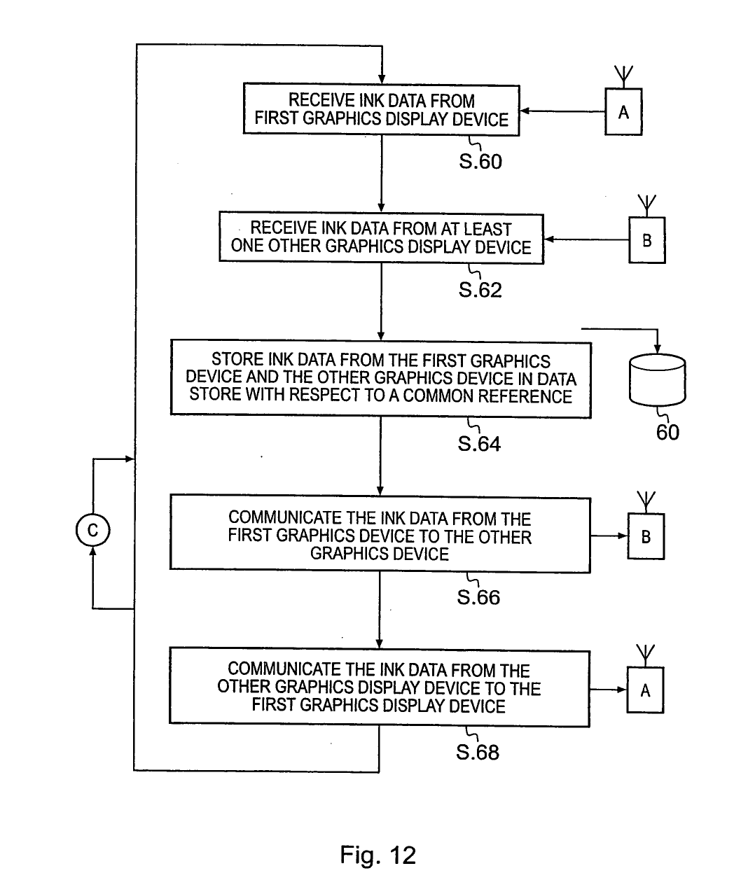

The overall operation of the graphics display server is illustrated by the flow diagram in FIG. 12. The steps of the operation of the graphics display server when exchanging ink data is illustrated in FIG. 12 and will now be described, with respect to illustrations in respect to for example mobile graphic display devices A, B and server 60.

S60: The graphics display server receives ink data from a first graphics display device. The first ink data is then stored in the data store by the plug-in server processor.

S62: The server then receives ink data from another graphics display device. This ink data is then stored in association with first ink data within the data store by the scribble plug-in processor.

S64: The ink data is stored from the first and other display devices in the data store with respect to a sequence indicating the order in which the ink data is received. In some embodiments the ink data is stored in association with an indication of the time when the ink data was received. The ink data may be stored with respect to a predetermined system of co-ordinates, which maybe fixed for all the graphics display devices. Accordingly, with knowledge of this fixed set of co-ordinates the graphics device can scale up or down the display of the ink data when this is received by these devices.

S66: The server then arranges for the ink data communicated from the first graphics display device to be communicated to the other graphic display device.

S68: The ink data from the other graphics display device is then communicated to the first graphics display device. Accordingly, the ink data is exchanged between graphics display devices.

According to the above description of example embodiments, it will be appreciated that one aspect of the present invention provides an apparatus for exchanging hand drawn data, the apparatus comprising

means for generating first ink data representative of drawing action applied to a touch sensitive display screen,

means for displaying images representative of the first ink data on the display screen,

means for communicating the first ink data from the apparatus to another such apparatus, via a wireless communications means and means for receiving other ink data from the other apparatus, the other ink data being representative of other drawing action, and

means for receiving the other ink data and means for generating in combination with the means for displaying images a representation of the other ink data with respect to the representation of the first ink data on the display screen means.

The apparatus may further include means for communicating a presence signal providing an indication that the apparatus is available to send and receive ink data to at least one other such apparatus. The apparatus may further include means for receiving a presence signal from the other apparatus, the presence signal being indicative that the other apparatus is available to send and/or receive ink data, and in response to the presence signal, means for displaying an indication that the other apparatus is available to receive ink data.

According to another aspect of the invention there is provided a server means for facilitating an exchange of ink data, the server means comprising

means for receiving ink data from a first graphics display means and receiving ink data from at least one other graphics display means,

means for storing the ink data from the first graphics display means and the ink data from the other graphics display means in a data storage means in accordance with a common reference space,

means for communicating the ink data from the first graphics display means to the other graphics display means, and

means for communicating the ink data from the other graphics display means to the first graphics display means.

The server means may include means for maintaining connection information identifying the first graphics display means and the other graphics display means. The connection information may include a list of graphics display means associated in accordance with a defined group. The server means may include means for identifying presence information in accordance with whether one or more of the predefined group of display means is available to exchange ink data, and consequent upon one or more display means being identified, means for communicating ink data from a graphics display means from the group to any of the other graphics display means of the group which are identified as being present.

Various modifications may be made to the example of embodiments herein before described without departing from the scope of the present invention.

1. A mobile graphics display device, comprising
a touch sensitive display screen coupled to a touch screen processor, the touch screen processor being operable to generate first ink data representative of an input drawing action applied to the touch sensitive display screen,
a graphics display and a graphics image processor operable to display images representative of at least the first ink data an the graphics display, and
a data processor operable in combination with a wireless communications processor
to communicate the first ink data from the mobile graphics display device to another graphics display device,
to receive other ink data created by the other graphics display device, the other ink data being representative of other drawing action, the graphics image processor being operable to generate a representation of the other ink data with respect to the representation of the first ink data according to a common reference, wherein the data processor is operable in combination with the wireless communications processor
to communicate a presence signal providing an indication that the mobile graphics device is available to send and move ink data to at least one other graphics display device of a predefined group of graphics display devices,
to receive a presence signal from the other graphics display device, the presence signal being indicative that the other graphics display device is available to send and/or receive ink data from the mobile graphics display device, the data processor being operable in response to the presence signal to display an indication on the graphics display screen that the other device is available to send and to receive ink data, and
following receipt of the presence signal from the other graphics display device, to send and to receive the ink data to and from the other graphics display device.

2. A mobile graphics display device as claimed in claim 1, wherein the data processor is operable in reverse to a command received via the touch screen to establish a connection with the other graphics display device, the ink data produced from drawing actions from the touch screen being communicated to the other graphics display device.

3. A mobile graphics display device as claimed claim 1 or 2, wherein the data processor is operable in combination with the graphics display processor to provide a iconic representation on the display screen representing the presence of the other graphics display device.

4. A mobile graphics display device as claimed in any preceding claim, wherein the data processor is operable to compression encode the ink data.

5. A mobile graphics display device as claimed in any preceding claim, wherein the wireless communications processor is operable in accordance with a wireless mobile radio communications interface to send and receive data via a radio access interface in accordance with the interface.

6. A mobile graphics display device as claimed in any preceding claim, wherein the data processor is responsive to an indication from the touch screen to communicate image data via the wireless communications processor to the other graphics display device.

7. A mobile graphics display device as claimed in claim 6, wherein the image data includes one of a URI address or an image file.

8. A server for use with at least one graphics display device according to any of claims 1 to 7, the server comprising
a data communications processor operable to receive ink data from a first graphics display device and to receive ink data from at least one other graphics display device,
a server control processor operable to store the ink data from the first graphics display device and the ink data from the other graphics display device in a data store in accordance with a sequence of receipt, wherein
the server control processor is operable in combination with the data communications processor to communicate the ink data from the first graphics display device to the other graphics display device, and to communicate the ink data from the other graphics display device to the first graphics display device, wherein the data communications processor includes a connection control processor operable to maintain connection information, the connection information including a list of graphics display devices associated in accordance with a defined group, and the server control processor is operable to identify presence information in accordance with whether one or more of the predefined group of devices is available to exchange ink data, and consequent upon one or more devices being identified, the server control processor is operable to communicate ink data from a device from the group to any of the other graphics display devices of the group which are identified as being present.

9. A server as claimed in claim 8, wherein the ink data communicated between the group of devices forms a communications session, and the server control processor is operable upon receipt of a request for ink data generated in association with a group from the communications session, to communicate the ink data from the session to the graphics display device requesting the ink data for the session.

10. A server as claimed in claim 9, wherein the server control processor is operable to compression encode at least some of the ink data received from the graphics display devices.

11. A server as claimed in claim 10, wherein the serve control processor is operable to compression encode ink data received from the graphics display devices after a predetermined time has lapsed since generation of the ink data.

12. A server as claimed in claims 8 to 11, wherein the server control processor is operable to store data representative of a time of receipt of the ink data.

13. A server as claimed in any of claims 8 to 12, wherein the server control processor is responsive to a request for a previously generated drawing data, to communicate data representative of the previously generated drawing data to a requesting graphics display device.

14. A server plug-in operable in combination with an instant messaging server and a data store, the plug-in being operable to receive ink data from a plurality of sources and to store the ink in the data store in association with a common reference space, to maintain connection information in association with the ink data stored in the data store, the connection information including a list of graphics display devices associated in accordance with a defined group to identify presence information in accordance with whether one or more of the predefined group of devices is available to exchange ink data, and consequent upon one or more devices being identified, to communicate ink data from a device from the group to any of the other graphics display devices of the group which are identified as being present.

15. A method of exchanging hand drawn data, the method comprising
generating first ink data representative of drawing action applied to a touch sensitive display screen,
displaying images representative of the first ink data on a graphics display,
communicating the first ink data from the mobile graphics display device to another graphics display device, via a wireless communications link and receiving other ink data from the other graphics display device, the other ink data being representative of other drawing action, and
receiving the other ink data and generating in combination with the graphics image processor a representation of the other ink data with respect to the representation of the first ink data,
communicating a presence signal providing an indication that the mobile graphics device is available to send and receive ink data to at least one other graphics display device of a predefined group of graphics display devices,
receiving a presence signal from the other graphics display device, the presence signal being indicative that the other graphics display device is available to send and/or receive ink data from the mobile graphics display device,
in response to the presence signal, displaying an indication on the graphics display screen that the other device is available to send and to receive ink data, and
processor being operable in response to the presence signal to display an indication on the graphics display screen that the other device is available to send and to receive ink data, and
following receipt of the presence signal from the other graphics display device to send and to receive the ink data to and from the other graphics display device.

16. A method of exchanging hand drawn data as claimed in claim 15, comprising
providing an iconic representation on the display screen representing the presence of other graphics display device.

17. A method of exchanging hand drawn data as claimed in any of claims 15 or 16, comprising
compression encoding the ink data.

18. A method of exchanging hand drawn data as claimed in any of claims 15, 16 or 17, comprising
communicating in response to an indication from the touch screen, image data via the wireless communications processor to the other graphics display device.

19. A method of exchanging hand drawn data as claimed in claim 18, wherein the data includes one of a URI address or an image file.

20. A method of exchanging hand drawn data as claimed in any of claims 15 to 19, the method comprising
receiving ink data from a first graphics display device and receiving ink data from at least one other graphic display device,
storing the ink data from the first graphics display device and the ink data from the other graphics display device in a data store in accordance with a common reference space,
communicating the ink data from the first graphics display device to the other graphics display device,
communicating the ink data from the other graphics display device to the first graphics display device,
maintaining connection information identifying the first graphics display device and the other graphics display device, the connection information including a list of graphics display devices associated with a defined group, wherein the communicating the ink data from the first graphics display device to the other graphics display device and from the other graphics display device to the first graphics display device, includes
identifying presence information in accordance with whether one or more of the predefined group of devices is available to exchange ink data, and consequent upon one or more devices being identified,
communicating ink data from a user from the group to any of the other graphics display devices of the group which are identified as being present.

21. A method of exchanging hand drawn data as claimed in claim 20, wherein the ink data communicated between the group of devices forms a communications session, the method comprising
communicating the ink data from the session to a graphics display device requesting the ink data for the session.

22. A method of exchanging hand drawn data as claimed in claim 21, comprising
compression encoding at least some of the ink data received from the graphics display devices.

23. A method of exchanging hand drawn data as claimed in claim 22, comprising
compression encoding ink data received from the graphics display devices after a predetermined time has lapsed since generation of the ink data.

24. A method of exchanging hand drawn data as claimed in any of claims 20 to 23, comprising
communicating data representative of the previously generated drawing to a requesting graphics display device, in response to a request for a previously generated drawing data.

25. A pair of graphics display devices, each device of the pair being a mobile graphics display device according to any of claims 1 to 7, each being provided with a Subscriber Identity Module associated with the same operator.

26. A signal representing first ink data produced by a mobile graphics device according to any of claims 1 to 7.

27. A data carrier representing a signal as claimed in claim 26.

28. A signal representing a combinations of ink data and non-ink format data representative of an image or picture data, produced by a mobile graphics display device according to any of claims 1 to 7.

29. A signal as claimed in claim 28, wherein the image data is one of a Universal Resource Identifier or an image file.

30. A computer program providing computer executable instructions, which when loaded on to a computer causes the computer to perform the method according to any of claims 15 to 24.

31. A computer program product having a computer readable medium with recorded thereon information signals representative of the computer program claimed in claim 30.

32. A signal bearer carrying the computer program according to claim 30.
